(19) United States
(12) Patent Application Publication
(10) Pub. No.: US 2004/0069346 A1
(43) Pub. Date: Apr. 15, 2004

(54) Exterior sprinkler system shutoff and drainage system

(76) Inventor: Robert Adrian, Highlands Ranch, CO (US)

Correspondence Address: LEE G. MEYER, ESQ., MEYER & ASSOCIATES, LLC, 17462 E. POWERS DRIVE, CENTENNIAL, CO, 80015-3046, US

(21) Appl. No.: 10/264,771

(22) Filed: Oct. 4, 2002

(51) Int. Cl. F16L 5/00

(52) U.S. Cl. 137/360

(57) ABSTRACT

A sprinkler winterization and drainage device and method for use in new and existing sprinkler systems that is capable of operation completely from the outside of a building. The devices and methods of the present invention may be used for sprinkler systems in residential homes, commercial or residential rentals, parks, schools and any other application where the main water supply conduit and main sprinkler supply line is located within the interior of a building. The device and method include a valve assembly including a valve located inside a building for shutting off the main sprinkler supply line from outside the building, while also providing for drainage of residual water in the valve assembly to the outside of the building. The device and methods of the present invention completely eliminate the necessity of entry into a building in order to perform sprinkler winterization.

### BACKGROUND OF THE INVENTION

1. Field of the Invention

The present invention relates generally to sprinkler shutoff valves; and, more particularly to shutoff valves for sprinkler winterization, which can be accessed from the exterior of an edifice.

2. Description of Related Art

Green lawns around office buildings, residential homes or schools are a sign of luxury and a source of pride for many Americans. Many of these lawns are watered by underground sprinkler systems that have sprinkler heads flush with the ground surface that rise when water is run through the system and return to their original position when the water pressure is eliminated. The sprinkler heads are connected together by piping and this piping is linked to a valve control box. If a large area is to be watered there may be several individual zones operated separately through the valve control box. The entire system draws water from a main sprinkler supply line located within a building structure to prevent it from exposure to harsh temperatures. These systems employ main shutoff valves on the water supply line located interior the building.

Many sprinkler systems are located in areas that have freezing temperatures in the winter. After the main valve is shutoff, the residual water in these systems, which is exposed to these freezing temperatures, must be drained prior to a freeze to prevent the pipes from rupturing as a result of expansion from ice formation. This process, called winterizing, involves draining water from the underground exterior portions of the system and from the piping that leads to the main sprinkler supply line, which is susceptible to freezing.

Current systems of winterizing sprinkler systems are laborious and time-consuming. This is mainly due to the first step in any winterizing process, which involves closing the main sprinkler supply line valve located inside the building. These valves are usually located near the main water supply shutoff in the building. After closing the main sprinkler supply line valve, the operator must return to the exterior of the building and open the drain plugs on the backflow prevention device to allow exterior piping to drain as well. At this point the sprinkler drain valves can be opened to allow the system to drain. Most likely, the sprinkler drain plugs will also need to be opened to allow for the water to drain out of the system due to inadequate capacity in the sprinkler drain valve itself for the water that needs to exit the system. The next step is to go back inside the building and open the valve petcock after placing a container below the valve to catch water draining from the petcock. Unfortunately, the drain valve may be in a crawlspace or other inconvenient location and access may be limited. The drain plug of the drain valve will not be replaced until the system is rendered operational again. Hence, the drain plug must then be kept in a safe place over the winter in order to use it again the following watering season.

Besides being a cumbersome, time-consuming and laborious process as the operator moves from the inside to the outside of the building multiple times, it also requires access to the interior of a building. This is merely an inconvenience for a homeowner, but can cause scheduling problems if the building is a commercial or residential rental. Potentially, the bulk of commercial or residential rental winterizations will need to be performed in the evenings when the commercial building is not in use or when the tenants of the residence are home, respectively. This is also when labor costs for such services are at a premium.

In addition, current protocols of winterization require, not only time, labor and scheduling finesse, but also cooperation from nature. In many climes, warm days require watering, but temperatures drop below freezing at night. Thus, sprinkler use is required during the day but the system needs to be drained at night. This condition requires multiple drainage operations. Additionally, weather is unpredictable and many systems may be damaged if a freeze occurs earlier than predicted. Once a freeze occurs, not only will many systems be damaged, but also the scheduling will become even more complex as the owner of office and residential rentals struggles to quickly winterize all the systems as quickly as possible to prevent further damage.

Many attempts have been made to overcome some or all of these difficulties but none of them have been successful. (See, e.g., U.S. Pat. No. 5,220,937 to Roberts; U.S. Pat. No. 5.014,731 to Westerberg; U.S. Pat. No. 6,123,093 to D'Antonio; U.S. Pat. No. 4,848,389 to Pirkle; U.S. Pat. No. 5,826,792 to Hasslinger; U.S. Pat. No. 5,413,134 to Burgess and U.S. Pat. No. 5,694,963 to Fredell) Winterization of sprinkler systems has remained a cumbersome and time-consuming task that requires access to the inside of a building and/or specialty components.

The present invention recognizes and addresses the necessity for an operator to be able to quickly and efficiently shutoff the main sprinkler supply line from outside a building and also drain the water within the system to the exterior of the building without need for containers or proximity to the petcock. Until the present invention, prior art devices have been incapable of allowing an operator to perform either of these tasks without entering a building or using specialty equipment.

Citation of the above documents is only a discussion of related art and not intended as an admission that any of the foregoing is pertinent prior art. All statements as to the date or representation as to the contents of these documents is based on subjective characterization of information available to the Applicants, and does not constitute any admission as to the accuracy of the dates or contents of these documents.

### SUMMARY OF THE INVENTION

A system for shutting off and draining a main sprinkler valve assemble located interior a building from the exterior of the building, while providing exterior drainage of the valve assembly to the exterior of the building is provided. In the broad aspect, a sprinkler winterization and drainage device has a valve located interior of a building, for shutting off water flow from a main water supply to a main sprinkler supply line which can be actuated from the exterior the building. A re-sealable drain communicates with the valve, for draining residual water in the device to the outside of said building. In one aspect the valve is mechanically actuated. In another, the valve is electrically activated by means of a solenoid. In one embodiment the actuation signal is by wireless signal to the electrically activated valve.

In accordance with the invention the re-sealable drain can be a threaded cap or a valved device, which is mechanically activated, or electrical. In one embodiment the actuation signal for the re-sealable drain valve is by wireless signal. The re-sealable drain is capable of evacuating water from the valve assembly to the exterior of building.

In a preferred embodiment the means for manipulating the valve comprises the valve stem, which extends from the valve to the exterior of the building. In another embodiment the device contains a standard faucet hose bib exterior the building in communication with the valve assemble which acts as a standard faucet when the sprinkler system is activated and the re-sealable drain when the system is deactivated.

In accordance with the method for performing a sprinkler winterizing procedure, a valve actuator in communication with a valve interior the building for shutting off water flow from a main water supply to a main sprinkler supply line is manipulated from the exterior of a building to close the valve; and a re-sealable drain in communication with the valve is opened in order to drain residual water from said valve to the outside of the building. In one embodiment the valve is manipulated manually. In another electrically.

Further objects of the invention are disclosed throughout other areas of the specification and claims.

### BRIEF DESCRIPTION OF THE DRAWINGS

The following drawings form part of the present specification and are included to further demonstrate certain embodiments. These embodiments may be better understood by reference to one or more of these drawings in combination with the detailed description of specific embodiments presented herein.

FIG. 1 is a sectional side view of the instant invention showing an embodiment for retrofit.

FIG. 2 is a sectional side view of the instant invention showing another embodiment.

FIG. 3 is a sectional side view of the instant invention showing another embodiment.

### DESCRIPTION OF ILLUSTRATIVE EMBODIMENTS

As can be seen from the drawings, the basic concepts of the present invention may be embodied in many different ways using readily available plumbing components or with specialized units created specifically for this purpose. The invention can be installed when a building is initially constructed or when a sprinkler system is first put in or it can be later added to an existing sprinkler system or building, as a retrofit.

For ease of description, the system of the present invention can be divided into external components i.e. proximate the external portion of the building and the internal components i.e. those interior the building. The demarcation between the inside and the outside is the freeze zone proximate the exterior wall of the building. Components that are not subject to freezing temperatures are considered interior components and those subject to freezing temperatures are considered exterior components. The freeze zone is all of the external area, as well as a certain amount of the area within the exterior wall as is well known by the skilled artisan.

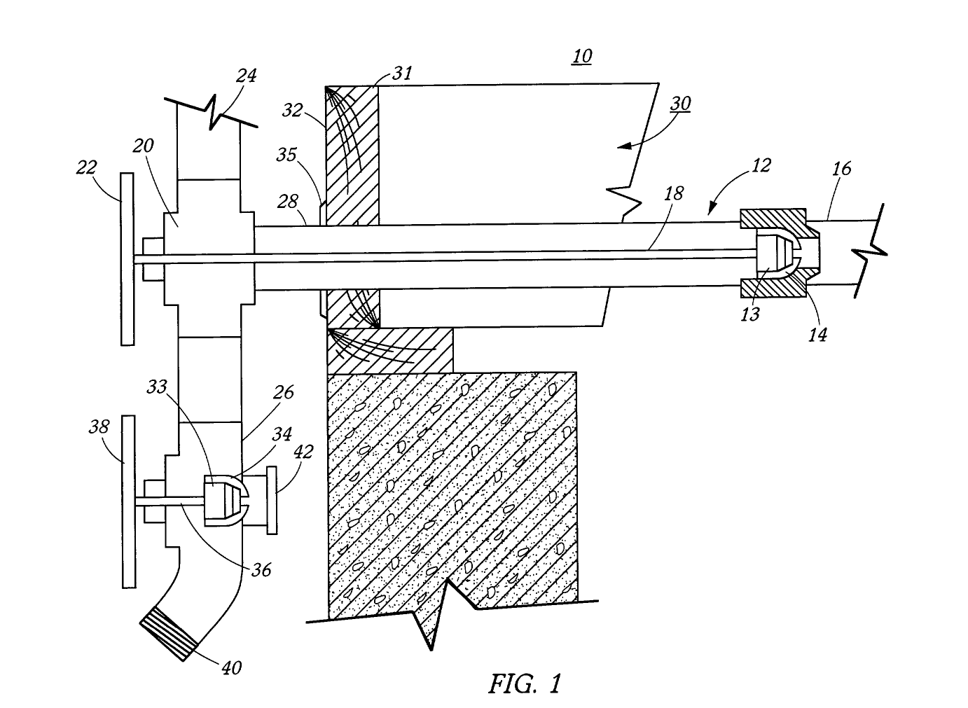

In FIG. 1, there is shown a sprinkler winterization valve and drainage system 10 in accordance with the instant invention, which is specifically adapted for retrofit to existing sprinkler systems. This particular configuration allows the use of a hose bib (faucet), which would otherwise be replaced by the assembly during sprinkler activation and as a re-sealable drain upon deactivation. In FIG. 1, the winterization valve and drainage system 10 has a main shutoff valve assembly 12 having a valve 13 and a valve seat 14 communicating with a main water supply conduit 16. A valve stem 18 extends from the valve 13 through the “T” portion 20 of main shutoff valve assembly 12 and communicates with handle 22. “T” portion 20 of main shutoff valve assembly 12 has a first port communicating on one side with main sprinkler conduit 24 and a second port communicating with a standard hose bib valve assembly (faucet) 26. Conduit 28, which comprises the interconnect conduit between the main water supply conduit 16 and the “T” portion 20 of main shutoff valve assembly 12, runs from the interior partition 30 of building wall 31 to the exterior partition 32. Standard hose bib valve assembly 26 comprises a valve 33, a valve seat 34, and a valve stem 36 connected to a handle 38 and has a threaded bib portion 40. Standard hose bib valve assembly 26 also has an anti-siphon device 42.

In operation main shutoff valve assembly 12, when open, allows water from main water supply conduit 16 to flow through valve seat 14 through “T” portion 20 into main sprinkler conduit 24 as well as a standard hose bib valve assembly 26. In this manner standard hose bib valve assembly 26 can be operated independently of main shutoff valve assembly 12 by manipulation of handle 38. During sprinkling weather, main shutoff valve assembly 12 remains open to allow full pressure flow of water through main sprinkler conduit 24 and standard hose bib valve assembly 26. At winterization and sprinkler system shut down, handle 22 is manipulated to seat valve 13 in valve seat 14 and thus close main shutoff valve assembly 12, ceasing flow through conduit 28. Conduit 28, however, still contains residual water, which would be susceptible to freezing proximate exterior partition 32. Once main shutoff valve assembly 12 is closed, standard hose bib valve assembly 26, which acts as a re-sealable drain, is opened to allow drainage of residual water in conduit 28 and main sprinkler conduit 24 as well as “T” portion 20. In this manner no additional drain valve is needed to drain the system.

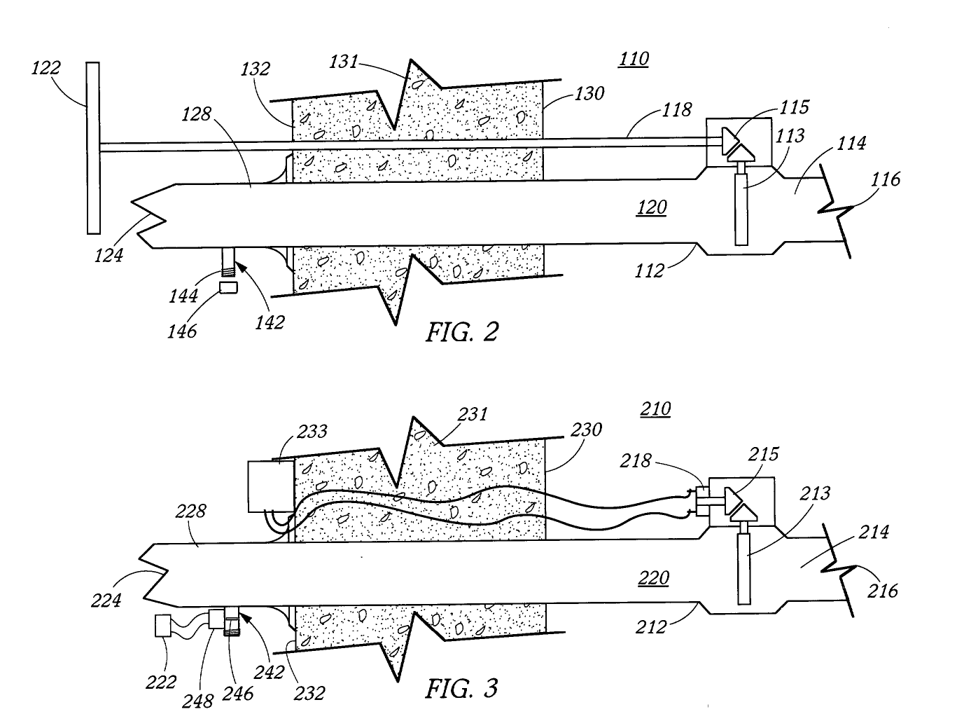

Turning to FIG. 2, there is shown another embodiment of a sprinkler winterization valve and drainage system 110 in accordance with the present invention. The sprinkler winterization valve and drainage system 110 has a main gate valve shutoff assembly 112 having; a downstream conduit portion 120 in communication with main sprinkler conduit 124, a gate valve 113 and a valve seat 114 communicating with a main water supply conduit 116. The main gate valve shutoff assembly 112 has an actuator interface 115 connected to gate valve 113 and a mechanical actuator 118 that extends from the actuator interface 115, through interior partition 130 and wall 131 beyond the exterior partition 132, and is connected to a handle 122. Main gate valve shutoff assembly 112 has a first port, which communicates with main water supply conduit 116 and a second port, which communicates with main sprinkler conduit 124. Main gate valve shutoff assembly 112 includes a re-sealable drain plug 142 situated exterior, the exterior partition 132. The re-sealable drain plug 142 has, on the end portion thereof a male threaded portion 144 about which a female threaded cap 146 is secured by mating engagement of the respective threaded portions.

In operation main gate valve shutoff assembly 112, when open, allows water from main water supply conduit 116 to flow through valve seat 114 of main gate valve shutoff assembly 112 through downstream conduit portion 120 into main sprinkler conduit 124. During sprinkling weather main gate valve shutoff assembly 112 remains open to allow full pressure flow of water through main sprinkler conduit 124 and re-sealable drain plug 142 remains closed. At winterization and sprinkler system shut down, handle 122 is manipulated to close main gate valve shutoff assembly 112, interrupting flow through conduit 128. Conduit 128, however, still contains residual water, which would be susceptible to freezing. Once main gate valve shutoff assembly 112 is closed, re-sealable drain plug 142 is opened to allow drainage of water in conduit 128 and main sprinkler conduit 124 as well as downstream conduit portion 120.

FIG. 3 shows another embodiment of a sprinkler winterization valve and drainage system 210 in accordance with the present invention. The winterization valve and drainage system 210 has a main gate valve shutoff assembly 212 having a downstream conduit portion 220 in communication with main sprinkler conduit 224, a gate valve 213, and a valve seat 214 communicating with a main water supply conduit 216. The main gate valve shutoff assembly 212 has an actuator interface 215 connected to gate valve 213 and a solenoid actuator 218 connected to the actuator interface 215. Solenoid actuator 218 is connected to a main solenoid activation switch 233, through interior partition 230 of wall of 231, and is located on exterior partition 232.

Main gate valve shutoff assembly 212 has a first port, which communicates with main water supply conduit 216 and a second port, which communicates with main sprinkler conduit 224. Main gate valve shutoff assembly 212 includes a re-sealable drain plug, 242 situated exterior of exterior partition 232. Re-sealable drain plug 242 has a re-sealable drain plug gate valve 246 and re-sealable drain plug solenoid actuator 248 connected to a drain plug solenoid activation switch 222.

In operation, main gate valve shutoff assembly 212, when open, allows water from main water supply conduit 216 to flow through valve seat 214 of main gate valve shutoff assembly 212 through downstream conduit portion 220 into main sprinkler conduit 224. During sprinkling weather, gate valve 213 remains open to allow full pressure flow of water through main sprinkler conduit 224. At winterization and sprinkler system shut down, drain plug solenoid activation switch 222 is manipulated to close gate valve 213, interrupting flow through conduit 228. Conduit 228, however, still contains residual water, which would be susceptible to freezing at exterior partition 232 of wall 231. Once main gate valve shutoff assembly 212 is closed, then re-sealable drain plug 242 is opened to allow drainage of water in conduit 228 and main sprinkler conduit 216 as well as downstream conduit portion 220.

Valves useful in accordance with the present invention can include a ball valve, a gate valve, a gate valve with pinion, a solenoid actuated gate mechanism, a standard pressure valve, or any other type of valve that includes a shutoff apparatus. A system utilizing a solenoid mechanism may also include a receiver capable of capturing a wireless signal from a switch transmitter to activate such solenoid.

The actuator of the present invention can be any mechanism that allows manipulation of the valve from the outside of the building. As an illustration, the actuator in FIG. 1 is an extended handle capable of manipulating the valve relative to the valve seat. The actuator may be mechanical or electrical either proximate the outside of the building or remote. FIG. 2 demonstrates a gate valve with an extended handle capable of manipulation of the valve from exterior the building. In FIG. 3, a solenoid activated gate valve is depicted where the valve is manipulated via an activation device on the exterior of the building.

In some embodiments of the present invention, the actuator can manipulate the valve and also actuate the re-sealable drain valve. Such actuators allow for a one-step winterization procedure. The drain of the present invention can include a standard faucet valve, ball cock valve, drain plug, petcock, or any other type of valve that allows for water to exit pipes. It can be mechanically operated or electrical. Fitting and pipe materials of the present invention may be copper, PVC or any other type of pipe used in the industry. Materials are of use in connecting the main water supply conduit to the interior end of the valve connecting the exterior portion of the valve to a drain, such as a standard hose bib, and connecting the exterior portion of the valve to the main sprinkler conduit, for example. Such types of fitting or pipe materials are well known to those skilled in the art.

At the point where the conduit exits the building, through the exterior partition there can be a cover plate 35 as shown in FIG. 1. Such cover plate may be desired for aesthetic purposes and to prevent insect entry into the building.

The method of winterizing a sprinkler system of the present invention is accomplished completely from the outside of a building in just a few minutes. First, the valve in the valve assembly is manipulated from the outside of a building to turn off the main sprinkler supply line located inside the building. Manipulation of the valve may occur with a handle located outside of the building that extends into the building and is capable of manipulating the interior valve. In addition, the valve may be manipulated by a solenoid mechanism capable of activation from the exterior of the building. After manipulation of the valve, which turns off the main sprinkler supply line, the residual water within the valve assembly is evacuated through a re-sealable drain by opening the drain, such as by turning the handle on a standard faucet valve or opening a petcock. This allows the water to be evacuated to the exterior of the building. The re-sealable drain may be left open the entire winter in order to allow residual water to drain.

In particular embodiments, the actuator is capable of manipulating the valve in order to shutoff the main sprinkler supply line and is also in communication with the re-sealable drain allowing water to evacuate the system to the exterior of the building. In this embodiment, the method becomes a one-step process as the water is shutoff and allowed to drain all in one step. Such method may include an electrical actuator, such as a solenoid, capable of activation from the outside of the building or from a wireless device. It may also include a single mechanical actuator, such as a handle, capable of manipulating the valve inside the building and the re-sealable drain at the same time. The mechanical or electrical actuator of this embodiment may be located at approximately chest height to avoid the operator having to bend over to reach the valve assembly of the present invention. This is particularly useful to operators with physical infirmities, such as the elderly or disabled.

The system is easily rendered operational the next growing season by closing the re-sealable drain and manipulating the actuator in order to open the valve within the valve assembly. This allows the water to flow from the main water supply into the main sprinkler supply line and out through the entire sprinkler system. The system is rendered operational entirely from the outside of the building in a few minutes.

The method of the present invention facilitates turning the system on and off multiple times in the spring or fall if the weather is not consistent. In the fall there may be sporadic frosts with periods of warm weather in-between where it is necessary to water the grass. The method of the present invention merely takes a few minutes allowing an operator to winterize a sprinkler system and turn it back on multiple times before sporadic frosts in the fall or spring and then easily turn the system back on in order to facilitate watering during the warm periods in-between the frosts without a large investment of time or labor.

The foregoing discussions, and examples, describe only specific embodiments of the present invention. It should be understood that a number of changes might be made, without departing from its essence. In this regard, it is intended that such changes—to the extent that they achieve substantially the same result, in substantially the same way—would still fall within the scope and spirit of the present invention.

What is claimed is:

1. A sprinkler winterization and drainage device comprising:
a) a valve assembly having a valve, located interior of a building, for shutting off water flow from a main water supply to a main sprinkler supply line, and having a valve actuator for manipulation of said valve from the exterior of said building;
b) a re-sealable drain communicating with said valve assembly, for draining residual water from said valve assembly to the exterior of said building.

2. The device of claim 1 wherein said valve is selected from a group consisting essentially of a gate valve, a ball valve, a gate valve with pinion, a solenoid operated gate valve, a solenoid operated ball valve, and a standard pressure valve.

3. The device of claim 1 wherein said actuator is mechanical or electrical.

4. The device of claim 3 wherein said actuator is electrical and includes a solenoid.

5. The device of claim 4 wherein said solenoid is activated by a wireless signal.

6. The device of claim 1 wherein said re-sealable drain is a petcock or a drain plug.

7. The device of claim 6 wherein said re-sealable drain plug comprises a male threaded portion for mating engagement with a female threaded cap.

8. The device of claim 1 wherein said re-sealable drain further comprises a drain valve having a drain valve actuator.

9. The device of claim 8 wherein said drain valve is selected from the group consisting of a standard valve, ball cock valve, and standard faucet valve

10. The device of claim 8 wherein said drain valve actuator is mechanical.

11. The device of claim 8 wherein said drain valve actuator is electrical.

12. The device of claim 8 wherein said drain valve actuator includes a solenoid.

13. The device of claim 12 wherein said solenoid is activated by a wireless signal.

14. A method for performing a sprinkler winterizing procedure, said method comprising the steps of:
a) manipulating a valve actuator from the exterior of a building, said actuator communicating with a valve assembly having a valve, located interior of a building, for shutting off water flow from a main water supply to a main sprinkler supply line; and
b) opening a re-sealable drain in communication with said valve assembly, in order to drain residual water from said valve assembly to the exterior of said building.

15. The method of claim 14, wherein said valve is selected from the group consisting essentially of a gate valve, a ball valve, a gate valve with pinion, a solenoid operated gate valve, a solenoid operated ball valve, and a standard pressure valve.

16. The method of claim 14, wherein said actuator is mechanical or electrical.

17. The method of claim 16 wherein said actuator is electrical and includes a solenoid.

18. The method of claim 14 wherein said solenoid is activated by a wireless signal.

19. The method of claim 14 wherein said re-sealable drain is selected from the group consisting of drain plug and a petcock.

20. The method of claim 14 wherein said re-sealable drain plug comprises a male threaded portion for mating engagement with a female threaded cap.

21. The method of claim 14 wherein said re-sealable drain further comprises a drain valve having a drain valve actuator

22. The method of claim 21 wherein said drain valve is selected from the group consisting of a standard valve, ball cock valve, and standard faucet valve.

23. The method of claim 21 wherein said drain valve actuator is mechanical or electrical.

24. The method of claim 23 wherein said drain valve actuator is electrical and includes a solenoid.

25. The method of claim 24 wherein said solenoid is activated by a wireless signal.

26. A sprinkler winterization and drainage device comprising:
a) a valve assembly having a valve, located interior of a building, for shutting off water flow from a main water supply to a main sprinkler supply line, having a mechanical valve actuator disposed interior said valve assembly for manipulation of said valve from the exterior of said building;
b) a re-sealable drain communicating with said valve assembly, for draining residual water from said valve assembly to the outside of said building wherein said re-sealable drain comprises a standard faucet valve
